(19) United States
(12) Patent Application Publication
(10) Pub. No.: US 2008/0109335 A1
(43) Pub. Date: May 8, 2008

(54) DELIVERING ELECTRONIC MESSAGES FROM A USER'S ELECTRONIC MESSAGE SERVICE PROVIDER TO A SYSTEM FOR FACILITATING FINANCIAL TRANSACTIONS

(76) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny M. Shieh, Austin, TX (US)

Correspondence Address: IBM CORP (AP);C/O AMY PATTILLO, P. O. BOX 161327, AUSTIN, TX, 78716, US

(21) Appl. No.: 11/557,787

(22) Filed: Nov. 8, 2006

(51) Int. Cl. G06Q 20/00; H04M 1/64

(52) U.S. Cl. 705/35; 379/67.1

(57) ABSTRACT

A financial transaction system detects an identifier for a user requesting a financial transaction at an interface of the financial transaction system. The financial transactions system accesses from the electronic message service provider for the user using the identifier, at least one electronic message addressed to the user and sent to the user over a network for delivery to the user by the electronic message service provider at least one system accessible via the network and logged into using the identifier. The accessed electronic message is delivered to the user at the interface for the financial transaction system.

### 1. TECHNICAL FIELD

The present invention relates in general to improved accessibility to electronic messages. In particular, the present invention relates to delivery of electronic messages, from a user's electronic messaging service provider, to a transaction system, when the user is present at an interface of the transaction system.

### 2. DESCRIPTION OF THE RELATED ART

While cellular and mobile telephones are becoming more accessible, wireless network service still does not extend to every area of the world. Further, even in areas where wireless network service is available, a user may not receive calls or messages because a user's cellular telephone is turned off, the user is not carrying the cellular telephone, or the battery for the cellular telephone does not have power remaining. Moreover, a user may only have service that delivers voice calls, and not electronic messages, to a cellular telephone device. Regardless of the reason that a user does not receive service or calls within an area, it would be advantageous to deliver electronic messages to a user at devices connected to a network, other than a cellular telephone device, in the event that the user cannot be contacted by cellular telephone or other personal, portable, wireless communication device.

Therefore, in view of the foregoing, the present invention provides a method, system, and program for delivery of electronic messages to a user at a transaction terminal. In particular, it would be advantageous to provide a method, system, and program for a transaction terminal that provides an interface for transactions with the user and is also enabled to receive electronic messages from a consumer's electronic messaging service provider and deliver the electronic messages to the consumer at the transaction terminal interface.

### SUMMARY OF THE INVENTION

Therefore, the present invention provides improved accessibility to electronic messages. In particular, the present invention provides for delivery of electronic messages, from a user's electronic messaging service provider, to a transaction system, when the user is present at an interface of the transaction system.

In one embodiment, a financial transaction system detects an identifier for a user requesting a financial transaction at an interface of the financial transaction system. The financial transactions system accesses from the electronic message service provider for the user using the identifier, at least one electronic message addressed to the user and sent to the user over a network for delivery to the user by the electronic message service provider at least one system accessible via the network and logged into using the identifier. The accessed electronic message is delivered to the user at the interface for the financial transaction system.

In addition, the financial transaction system enables the user at the interface to compose electronic messages. The financial transaction system controls delivery of the electronic messages to the addressees.

The financial transaction system may receive electronic messages from a user's electronic message service provider independent of a request from the financial transaction system to the electronic message service provider. The financial transaction system stores the electronic message in associated with the identifier for the user. When the user is next detected at the interface of the financial transaction system, the financial transaction system delivers the stored electronic message to the user at the interface.

The financial transaction system detects whether an electronic message accessed for a user is marked as a list. For an electronic message marked as a list, the financial transaction system compares the items in the contents of the message with at least one item associated with the financial transaction and delivers the electronic message to the interface indicating which of the items still need to be purchased in view of the current transaction.

The financial transaction system detects whether an electronic message includes a reply option set. For an electronic message marked with a reply option set, the financial transaction system prompts the user to select a reply to the electronic message and limits the selection of responses to those responses specified in the reply option.

The financial transaction system detects a voice message recorded by the user at the interface. The financial transaction system stores the voice message in associated with a record of the financial transaction. In addition, the financial transaction delivers, to the user's electronic message service provider, an additional electronic message with the voice recording and record of the financial transaction.

The financial transaction system, in one embodiment, detects the user present an account identification and based on the account identification, accesses the identifier indicating the electronic message service provider and messaging identifier for accessing electronic messages from the electronic message service provider. In another embodiment, the financial transaction system detects the user present a portable identification with a financial service provider identifier, an account identifier, and an electronic message service provider identifier. The financial transaction system presents the account identifier to both the financial service provider and the electronic message service provider to access the user accounts from each provider.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram illustrating one example of a network environment for delivering electronic messages from a user's electronic messaging service to the user at a transaction terminal;

FIG. 2 is a block diagram depicting one embodiment of a computer system in which the present invention may be implemented;

FIG. 3 is a block diagram illustrating one example of components of a messaging controller of a transaction system;

FIG. 4 is an illustrative block diagram depicting a user interface of a transaction system at which a user receives an electronic message managed by a separate electronic message service provider;

FIG. 5 is an illustrative block diagram of a user interface of a transaction system from which a user sends a reply to an electronic message;

FIG. 6 is an illustrative diagram depicting additional examples of reply options selected for a user and displayed at a user interface of a transaction system;

FIG. 7 is an illustrative diagram of an electronic message composition interface for enabling a sender to set options associated with an electronic message being handled by a transaction system;

FIG. 8 is a block diagram depicting one embodiment of components of a portable account device;

FIG. 9 is an illustrative diagram illustrating one embodiment of an electronic message delivery system based on an electronic message service provider specified on a portable account device;

FIG. 10 is a high level logic flowchart depicting a process and program for controlling delivery of electronic messages to a user interface within a transaction system;

FIG. 11 is a high level logic flowchart illustrating a process and program for a messaging controller of a transaction system to manage voice messages recorded by a user at a user interface; and

FIG. 12 is a high level logic flowchart depicting a process and program for a messaging controller of a transaction system to manage electronic messages marked as lists.

### DETAILED DESCRIPTION OF THE PREFERRED EMBODIMENT

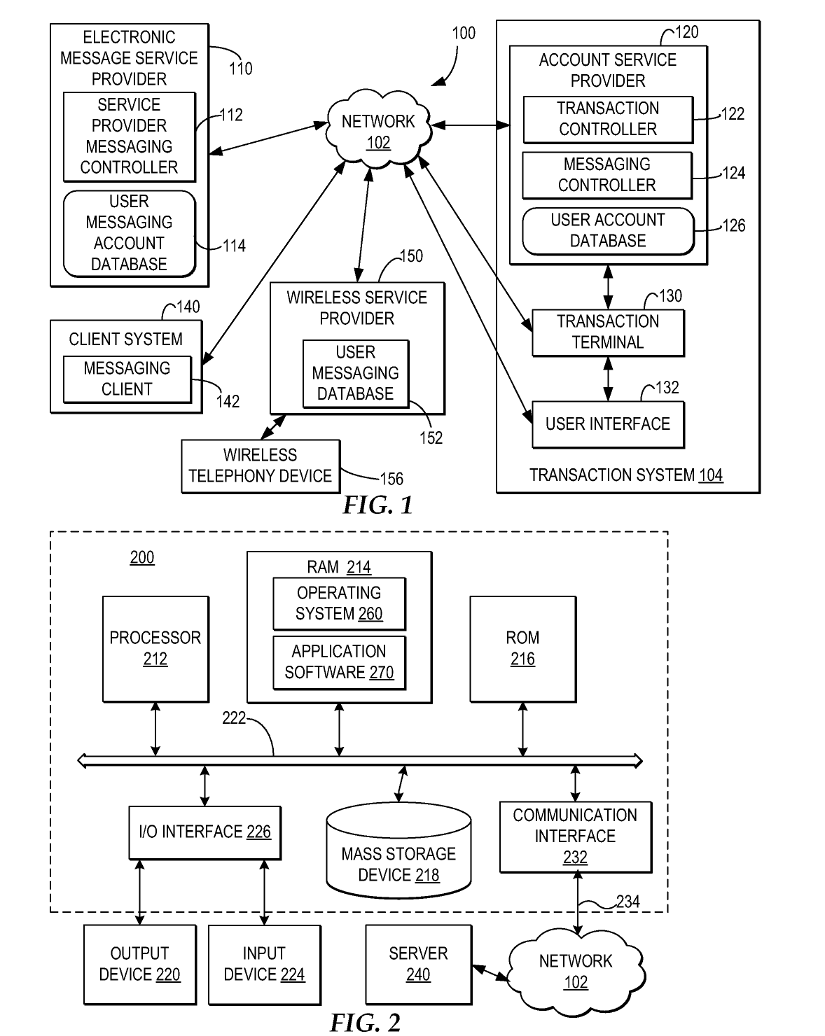

With reference now to FIG. 1, a block diagram illustrates one example of a network environment for delivering electronic messages from a user's electronic messaging service to the user at a transaction terminal. It is important to note that network environment 100 is illustrative of one type of network environment in which personal, electronic messages may be delivered to a user at a transaction terminal, however, the electronic message delivery method, system, and program may be implemented in other network environments. In addition, it is important to note that the distribution of systems within network environment 100 is illustrative of a distribution of systems; however, other distributions of systems within a network environment may be implemented.

As illustrated, multiple systems within network environment 100 may be communicatively connected via network 102, which is the medium used to provide communications links between various devices and computer communicatively connected. Network 102 may include permanent connections such as wire or fiber optics cables and temporary connections made through telephone connections and wireless transmission connections, for example. Network 102 may represent both packet-switching based and telephony based networks, local area and wide area networks, public and private networks. It will be understood that FIG. 1 is representative of one example of a distributed communication network for supporting electronic message accessibility; however other network configurations and network components may be implemented for supporting and implementing electronic message accessibility in the present invention. Additionally, network environment 100 supports multiple types and levels of communication protocols for facilitating composition, distribution, and viewing of multiple types of electronic message communications.

Network environment 100 may implement multiple types of network architectures. In one example, network environment 100 may be implemented using a client/server architecture, where computing systems requesting data or processes are referred to as clients and computing systems processing data requests and processes are referred to as servers. It will be understood that a client system may perform as both a client and server and a server system may perform as both a client and a server, within a client/server architecture. In addition, it will be understood that other types of network architectures and combinations of network architectures may be implemented.

In the embodiment, a transaction system 104 includes an account service provider 120, a transaction terminal 130, and a user interface 132. It will be understood that transaction system 104 may include additional servers and components communicatively connected via a network, such as network 102. In addition, it will be understood that different components within transaction system 104 may be provided by different entities. For example, one entity may control account service provider 120 and another entity may provide transaction terminal 130. Account service provider 120 may interface with multiple transaction terminals and transaction terminal 130 may interface with multiple user interfaces. Transaction terminal 130 and user interface 132 may be integrated within wireless and wired communication systems.

User interface 132 may provide one or more input interfaces including, but not limited to, a microphone, a touchpad, a keypad, and a card reader. In addition, user interface 132 may provide one or more output interfaces, including, but not limited to, a printer, a speaker, or a display interface. User interface 132 may be locally connected to transaction terminal 130 or connected to transaction terminal 130 via network 102. In addition, user interface 132 may detect additional devices, such as a portable computing device, which communicatively connects to user interface 132 via a local wireless network.

Account service provider 120 controls transactions between parties. A transaction controller 122 of account service provider 120 receives transaction requests from one or more transaction terminals, such as transaction terminal 130 via one or more types of networks, such as network 102. Transaction controller 122 controls the process for authorizing a transaction and for marking the accounts of the parties to the transaction. It will be understood that to authorize or complete a transaction, account service provider 120 may communicate with other account service providers via one or more networks, such as network 102. In addition, it will be understood that account service provider 120 may implement one or more server systems communicatively connected for providing the account transaction services of one or more separate account service providers.

In one example, account service provider 120 is a credit card service provider or banking service provider and the transaction is a financial transaction. For example, a user presents a portable account device, such as a credit card or banking card, at user interface 132 and user interface 132 detects the user's account number and account service provider identification from the credit card or banking card. In particular, user interface 132 may include one or more types of readers, including, but not limited to, a magnetic card stripe reader and a radio-frequency identifier (RFID) reader, for reading a portable identification device. User interface 132 transmits the account number and account service provider identification to transaction terminal 130. Transaction terminal 130 detects a transaction request for the user to purchase goods from a business for a particular cost or to access cash. Transaction terminal 130 sends the transaction request to charge the particular cost to the user's account number at the identified account service provider to account service provider 120. Account service provider 120 may be the user's service provider or account service provider 120 may communicate with the user's service provider to authorize and complete the requested transaction. In addition, account service provider 120 may prompt transaction terminal 130 for particular types of information, from the user, entered at transaction terminal 130 or user interface 132, to complete or authorize the transaction.

In another example, account service provider 120 is a service provider and user interface 132 is the terminal at which a user completes a transaction previously started at another location. For example, a user may present a portable account device at user interface 132 and user interface 132 detects the user's account number and account service provider identification, but account service provider 120 uses the user's account number and account service provider identification to access the transaction previously started by the user. For example, a user may present a credit card at an airline check-in point and the user's credit card number and credit card provider identification is used to access the ticket previously purchased by the user with the credit card number and to complete the transaction by issuing the purchased ticket.

Account service provider 120 includes a user account database 126 which includes information for each user account. The information for each user account may include, but is not limited to, an account number, a password, one or more account service providers, one or more messaging service providers and one or more settings and preferences for receiving electronic messages at a transaction interface. In addition, records of transactions and other user data may be stored in user account database 126.

In particular, in addition to account service provider 120 managing financial or service transactions, account service provider 120 includes a messaging controller 124 for controlling delivery of electronic messages to user interface 132 from a user's electronic messaging service provider to the user when the user present identification at user interface 132.

In one example, messaging controller 124 detects the account identifier provided by the user at user interface 132 from transaction terminal 130. Messaging controller 124 looks up the identifier in user account database 126, as previously described, where user account database 126 includes account information for each user, searchable by user identifier. In particular, account information for a user may include the network address for an electronic message service provider and the login information required for messaging controller 124 to login to the electronic message service provider and request delivery of any electronic messages stored by the electronic message service provider in the current user's storage account with the electronic message service provider.

In particular, in the example, the current user's account information includes a network address for electronic message service provider 110 and login information, such as a user name and password, required for logging into and accessing electronic messages stored for the current user in a user messaging account database 114. Messaging controller 124 transmits, to electronic message service provider 110, the login information for the current user. Service provider messaging controller 112 accesses the electronic messages stored for the current user in user messaging account database 114 and controls delivery of the accessed messages to messaging controller 124. Next, messaging controller 124 filters the delivered messages, from service provider messaging controller 112, for output at user interface 132 and messaging controller 124 delivers the messages to the user via transaction terminal 130, which transmits the messages to user interface 132. Alternatively, messaging controller 124 may deliver the messages directly to user interface 132.

In addition, messaging controller 124 may control delivery of a response, by the user, from user interface 132. In one example, a user may select a response to a message received at user interface 132 and messaging controller 124 assigns an address to the message and delivers the message to an electronic message service provider for the addressee.

Further, messaging controller 124 may associate, with a transaction, electronic messages received for the user, responses to electronic messages sent by the user, and voice messages recorded by the user at user interface 132. In one example, a user may select, while completing a transaction at user interface 132, to record a voice message for storage with a record of the transaction in user account database 126. Message controller 124 receives the recorded voice message, stores the recorded voice message with a record of the transaction, and may also address to the user the voice message and transaction record as an electronic message and send the electronic message to the user's electronic message service provider for access by the user at another system at which the user may access electronic messages managed by the user's electronic message service provider.

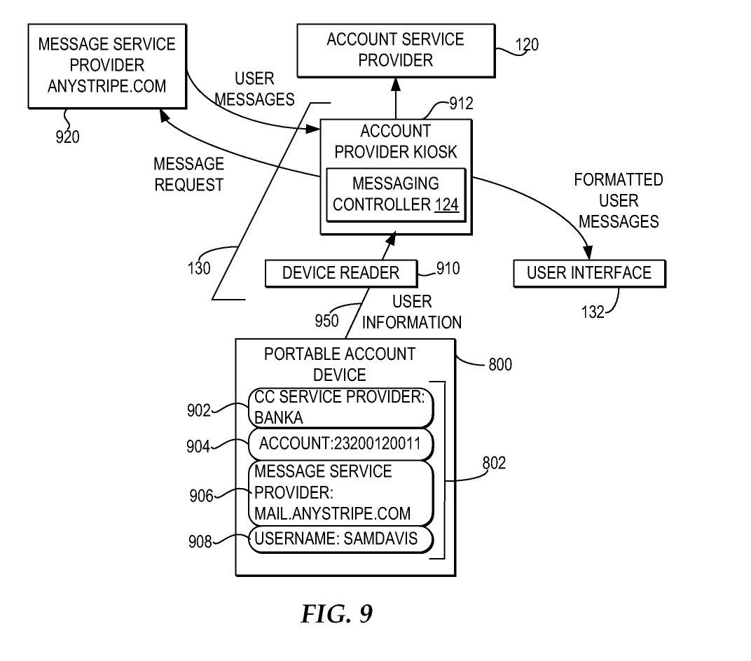

Additionally, while messaging controller 124 is depicted as a component of account service provider 120 within transaction system 104, as will be further described with reference to FIG. 9, messaging controller 124 may be a component of transaction terminal 130 or other systems within transaction system 104. In particular, it is important to note that within transaction system 104, transaction terminal 130 may communicate with multiple varying account service providers, wherein transaction terminal 130 including messaging controller 124 would enable transaction terminal 130 to facilitate message delivery along with facilitating transactions between a user and an account service provider.

It is important to note that multiple, separate systems may request delivery of electronic messages for a current user from electronic message service provider 110. As previously described, messaging controller 124 may request delivery of electronic messages for a current user from service provider messaging controller 112. In another example, a user may access electronic messages from electronic message service provider 110 at a client system, such as client system 140, through which a user selectively logs in to electronic message service provider 110 using a messaging client 142, such as a browser application or a client-side messaging application. In another example, a user with a wireless service plan for a personal wireless telephony device 156 may provide a network address for electronic message service provider 110 and the user's login information to a wireless telephone service provider 150. Wireless telephone service provider 150 stores the network information in a user messaging database 152 and, using the stored information, periodically accesses electronic message service provider 110, for the user, and delivers accessed electronic messages to personal wireless telephony device 156. It will be understood that additional or alternate system may be implemented for receiving electronic messages from electronic message service provider 110.

Additionally, separate systems may transmit electronic messages to electronic message service provider 110. For example, a user may compose and send an electronic message to a user from client system 140, via messaging client 142 or from wireless telephony device 156, via wireless service provider 150. In another example, a user may select to reply to an electronic message from wireless telephony device 156, where wireless service provider 150 controls transmission of an electronic message to electronic message service provider for delivery to an addressee. Further, in another example, as already noted, a user may select to reply to an electronic message from user interface 132, wherein messaging controller 124 receives the reply message, addresses the reply message, and transmits the electronic message to electronic message service provider 110 or another service provider for the addressee. In one example, the user composes an electronic message using a static input interface of user interface 132. In another example, a user requests user interface 132 communicatively connect to the user's portable electronic device, such as a telephony device, on which the user composes electronic messages, and the user's portable electronic device transmits the composed electronic messages to user interface 132, for distribution to electronic message service provider 110 by messaging controller 124 for the user. It will be understood that additional or alternate systems may be implemented for transmitting electronic messages to electronic message service provider 110.

Electronic message service provider 110, in one example, facilitates one or more accounts to one or more users. For each account, electronic message service provider 110 specifies a network identifier that uniquely identifies the account. In addition, the network identifier may identify electronic message service provider 110. In addition, for each user or each account, electronic message service provider 110 may specify login information, which may be the same as or include the network identifier, and may specify an authentication requirement, such as a password requirement or a biometric entry requirement.

Electronic message service provider 110 receives electronic messages addressed to one of the assigned network identifiers and stores the electronic messages in user message account database 114 according to network identifier. As previously described, a user may access the electronic messages stored in user message account database 114 from a system that accesses electronic message service provider 110 and provides the user's login information. In addition, electronic message service provider 110 may automatically forward an electronic message to messaging controller 124 of transaction system 104 for storage in association with a user account, such that if the user is detected by transaction system 104, the electronic message is already available at transactions system 104 for delivery to the user. Electronic message service provider 110 may receive electronic message marked to be forwarded or may receive a request from the user set in user messaging account database 114 to automatically forward all or particular electronic messages.

It is important to note that the term “electronic message” as used herein, may include, but is not limited to, an email message, an instant message, a text message, a voice message, a video message, or any other type of communication that is transmittable over network 102. Electronic message service provider 110 may facilitate storage and delivery of one or more types of electronic messages. In addition, electronic message service provider 110 may support the storage and delivery of electronic messages transmitted using varying types of messaging protocols. Electronic message service provider 110 or messaging controller 124 may convert electronic messages from one messaging protocol to another for facilitating communication between systems.

Referring now to FIG. 2, a block diagram illustrates one embodiment of a computer system in which the present invention may be implemented. The controllers and systems of the present invention may be executed in a variety of systems, including a variety of computing systems, such as computer system 200, communicatively connected to a network, such as network 202.

Computer system 200 includes a bus 222 or other communication device for communicating information within computer system 200, and at least one processing device such as processor 212, coupled to bus 222 for processing information. Bus 222 preferably includes low-latency and higher latency paths that are connected by bridges and adapters and controlled within computer system 200 by multiple bus controllers. When implemented as a server, computer system 200 may include multiple processors designed to improve network servicing power. Where multiple processors share bus 222, an additional controller (not depicted) for managing bus access and locks may be implemented.

Processor 212 may be a general-purpose processor such as IBM's PowerPC™ processor that, during normal operation, processes data under the control of an operating system 260, application software 270, middleware (not depicted), and other code accessible from a dynamic storage device such as random access memory (RAM) 214, a static storage device such as Read Only Memory (ROM) 216, a data storage device, such as mass storage device 218, or other data storage medium.

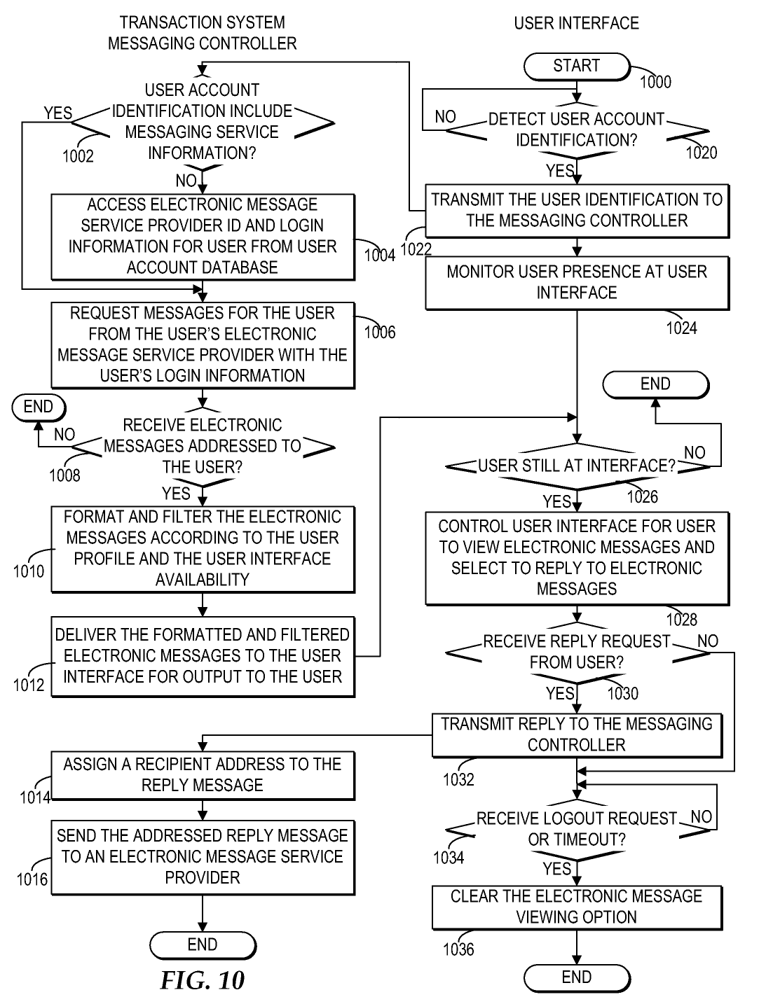

In one embodiment, the operations performed by processor 212 may control delivery of electronic messages between a user's electronic message service provider and a system for facilitating financial transactions with the user, as depicted in the operations of flowcharts of FIGS. 10-12 and other operations described herein. Operations performed by processor 212 may be requested by operating system 260, application software 270, middleware or other code or the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 200 to perform a process according to the present invention. The term “machine-readable medium” as used herein includes any medium that participates in providing instructions to processor 212 or other components of computer system 200 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 200 can read and which is suitable for storing instructions. In the present embodiment, an example of a non-volatile medium is mass storage device 218 which as depicted is an internal component of computer system 200, but will be understood to also be provided by an external device. Volatile media include dynamic memory such as RAM 214. Transmission media include coaxial cables, copper wire or fiber optics, including the wires that comprise bus 222. Transmission media can also take the form of acoustic or light waves, such as those generated during radio frequency or infrared data communications.

Moreover, the present invention may be downloaded or distributed as a computer program product, wherein the program instructions may be transferred from a remote computer such as a server 240 to requesting computer system 200 by way of data signals embodied in a carrier wave or other propagation medium via network 202 to a network link 234 (e.g. a modem or network connection) to a communications interface 232 coupled to bus 222. In one example, where processor 212 includes multiple processor elements is, a processing task distributed among the processor elements, whether locally or via a network, may represent a consumer program product, where the processing task includes program instructions for performing a process or program instructions for accessing Java (Java is a registered trademark of Sun Microsystems, Inc.) objects or other executables for performing a process. Communications interface 232 provides a two-way data communications coupling to network link 234 that may be connected, for example, to a local area network (LAN), wide area network (WAN), or directly to an Internet Service Provider (ISP). In particular, network link 234 may provide wired and/or wireless network communications to one or more networks, such as network 202. Further, although not depicted, communication interface 232 may include software, such as device drivers, hardware, such as adapters, and other controllers that enable communication. When implemented as a server, computer system 200 may include multiple communication interfaces accessible via multiple peripheral component interconnect (PCI) bus bridges connected to an input/output controller, for example. In this manner, computer system 200 allows connections to multiple clients via multiple separate ports and each port may also support multiple connections to multiple clients.

Network link 234 and network 202 both use electrical, electromagnetic, or optical signals that carry digital data streams. The signals through the various networks and the signals on network link 234 and through communication interface 232, which carry the digital data to and from computer system 500, may be forms of carrier waves transporting the information.

In addition, computer system 200 may include multiple peripheral components that facilitate input and output. These peripheral components are connected to multiple controllers, adapters, and expansion slots, such as input/output (I/O) interface 226, coupled to one of the multiple levels of bus 222. For example, input device 224 may include, for example, a microphone, a video capture device, a card reader, a body scanning system, a keyboard, a mouse, or other input peripheral device, communicatively enabled on bus 222 via I/O interface 226 controlling inputs. In addition, for example, an output device 220 communicatively enabled on bus 222 via I/O interface 226 for controlling outputs may include, for example, one or more graphical display devices, audio speakers, and tactile detectable output interfaces, but may also include other output interfaces. In alternate embodiments of the present invention, additional or alternate input and output peripheral components may be added.

Those of ordinary skill in the art will appreciate that the hardware depicted in FIG. 2 may vary. Furthermore, those of ordinary skill in the art will appreciate that the depicted example is not meant to imply architectural limitations with respect to the present invention.

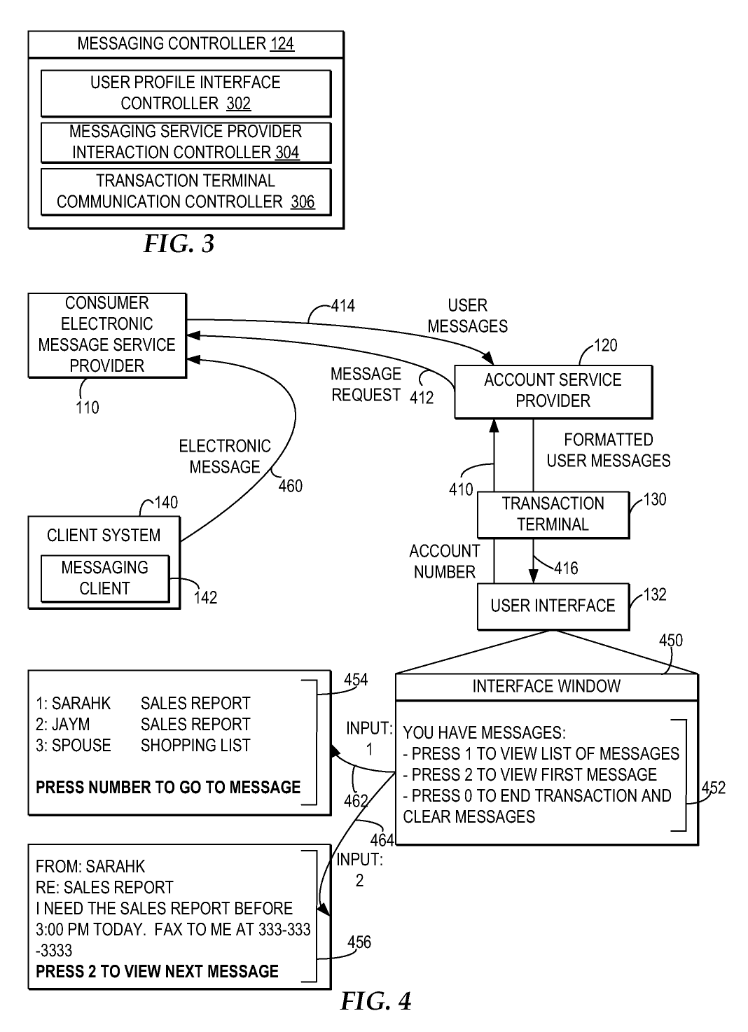

With reference now to FIG. 3, a block diagram illustrates one example of components of a messaging controller of a transaction system. It is important to note that additional or alternate components may be implemented within messaging controller 124. In addition, as previously noted, messaging controller 124 may be implemented within one or more systems within transaction system 104.

In the example, messaging controller 124 includes a user profile interface controller 302. User profile interface controller 302 controls entry of a network identifier and login information to associate with the user's account identifier in user account database 126.

User profile interface controller 302 may enable a user to provide a network identifier and login information via user interface 132. In addition, user profile interface controller 302 may enable a user to login, via a client system, such as client system 140, to user profile interface controller 302 to adjust the user's information within user account database 126, such as the user's network identifier and login information. Further, user profile interface controller 302 may enable electronic message service provider 110 to automatically update a user's account in user account database 126, with the network identifier and the user's login information. In particular, a user may request electronic message service provider 110 provide the network identifier and the user's login information to user profile interface controller 302 or electronic message service provider 110 may enter a service agreement with credit card service provider 120 to provide login information for customers of both electronic message service provider 110 and credit card service provider 120.

In addition, in the example, messaging controller 124 includes a messaging service provider interaction controller 304. Messaging service provider interaction controller 304 specifically controls requests to electronic message service providers for electronic messages for a current user available at a user interface, such as user interface 132. In addition, messaging service provider interaction controller 304 receives delivery of the electronic messages for a current user and marks the electronic messages with the current user's account identifier when received.

Once electronic messages for a particular user are received and marked by messaging service provider interaction controller 304, transaction terminal communication controller 306 controls delivery of the electronic messages to a particular user interface accessible to the current user. In controlling delivery of the electronic messages to a particular user interface, transaction terminal communication controller 306 may control the information and selectable options output to a user interface for the user to view the received electronic messages. In addition, transaction terminal communication controller 306 may format and filter electronic messages for output to a particular user interface.

In one example, transaction terminal communication controller 306 may filter electronic messages based on filtering preferences set by the current user in association with the user's account identifier in user account database 126. Filtering requirements and filtering preferences may filter out electronic messages that cannot be output at user interface 132, may filter out electronic messages according to criteria including, but not limited to, the size of the electronic message, the sender of the electronic message, whether there are attachments to the electronic message, whether an electronic message is encrypted, and the type of the electronic message.

In addition, in filtering electronic messages, transaction terminal communication controller 306 may detect that an electronic message is marked as a list and compare the listed items in the electronic message with the current items being purchased during a transaction. Transaction terminal communication controller 306 prepares a new electronic message or marks the current electronic message to indicate those items on the list that are not yet purchased. In addition, transaction terminal communication controller 306 may generate an electronic message for return by messaging service provider interaction controller 304 to the user's electronic message service provider indicating those items on the list that are not yet purchased.

Transaction terminal communication controller 306 may also filter and format an electronic message with a reply option. For example, an electronic message may include a reply option specified in the message, where the user composing the message specifies the reply options. In another example, limited reply options may be required for a particular user interface, such that the time provided for a user to reply to an electronic message is minimized. Transaction terminal communication controller 306 formats the electronic message for output with the specified reply options. In addition, transaction terminal communication controller 306 receives the reply messages, formats the reply messages, addresses the reply messages, and directs messaging service provider interaction controller 304 to send the reply messages to the addressee.

Additionally, transaction terminal communication controller 306 receives messages, recorded by the user at the user interface, and directed for storage with the transaction record. For example, a user may request that a voice recording, a video recording, or a text message be stored with the transaction record. Transaction terminal communication controller 306 formats the messages and stores the messages with the transaction record. In addition, transaction terminal communication controller 306 may compose an electronic message to the user with the transaction record and recorded message and direct messaging service provider interaction controller 304 to send the electronic message to the user. Additionally, a user may access the transaction record and associated recordings via user profile interface controller 302, through which a user may view a transaction record and select to view or listen to a recording associated with a transaction record.

Referring now to FIG. 4, an illustrative block diagram depicts a user interface of a transaction system at which a user receives an electronic message managed by a separate electronic message service provider. It will be understood that while one flow of data to a transaction system is illustrated, other flows of data and options for a user to view electronic messages at a user interface of a transaction system, may be implemented.

In the example, a sender sends an electronic message, as illustrated at reference numeral 460, from client system 140 via a messaging client 142, to a network address facilitated by electronic message service provider 110. In particular, messaging client 142 provides an interface through which a sender may address and compose an electronic message.

A user at user interface 132 provides a transaction account number. As illustrated at reference numeral 410, user interface 132 sends the account number to transaction terminal 130 and transaction terminal 130 passes the account number to account service provider 120. Account service provider 120 looks up, in user account database 126, the messaging account information associated with the transaction account number. In the example, the messaging service provider for the user is electronic message service provider 110.

Next, as illustrated at reference numeral 412, messaging controller 124 within account service provider 120 sends a request, to electronic message service provider 110 for the electronic messages associated with the selected messaging account. Electronic message service provider 110 detects electronic messages stored for the requested messaging account and transmits the stored messages to account service provider 120, as illustrated at reference numeral 414. Messaging controller 124 within account service provider 120 formats electronic messages with an identifier of the transaction account number and filters the electronic messages, as previously described with reference to FIG. 3. As illustrated at reference numeral 416, messaging controller 124 passes the formatted electronic messages to transaction terminal 130, which then distributes the formatted electronic messages to user interface 132, at which the transaction account number was detected.

Via a display window 450 of user interface 132, a user may view electronic messages. In the example, in viewing electronic messages, a user is first presented with a menu of options for selecting to view electronic messages. As previously described, transaction terminal communication controller 306 of messaging controller 124, may control the distribution of electronic messages, but may also control the output of and response to a menu of selectable options by which a user selects to view electronic messages. In addition, either of transaction terminal 130 and user interface 132 may control the output of and response to a menu of selectable options by which a user selects to view electronic messages.

In particular, in the example, a menu 452 includes multiple selectable options, for selection by a touchpad or other input interface, for a user to “press 1 to view list of messages”, “press 2 to view first message”, and “press 0 to end transaction and clear messages.” It will be understood that additional or alternate menu options may be presented to a user via user interface 132.

In the example, in response to the display of menu 452, if the user selects “1”, as illustrated at reference numeral 462, the information displayed within interface window 450 is updated to menu 454. Menu 454 specifies multiple selectable options of specific electronic messages available for the user with instructions to press a number to go to the messages, where the numbers as assigned as “1” to the electronic message from “sarahK”, “2” to the electronic message from “jaym”, and “3” to the electronic message from “spouse”. While in the example all electronic messages are listed, in additional or alternate embodiments, selections of electronic messages may be listed and electronic messages may be ordered according to one or more selected criteria.

In addition, in the example, in response to the display of menu 452, if the user selects “2”, as illustrated at reference numeral 464, the information displayed within interface window 450 is updated to electronic message display 456. Electronic message display 456 includes the contents of the first electronic message, from “sarahK”, where the electronic message is “re: sales report” and the text of the message reads “I need the sales report before 3:00 PM today. Fax to me at 333-333-3333.” In addition, electronic message display 456 includes an option for the user to “press 2 to view next message” or “ss 3 to return to the main menu.”

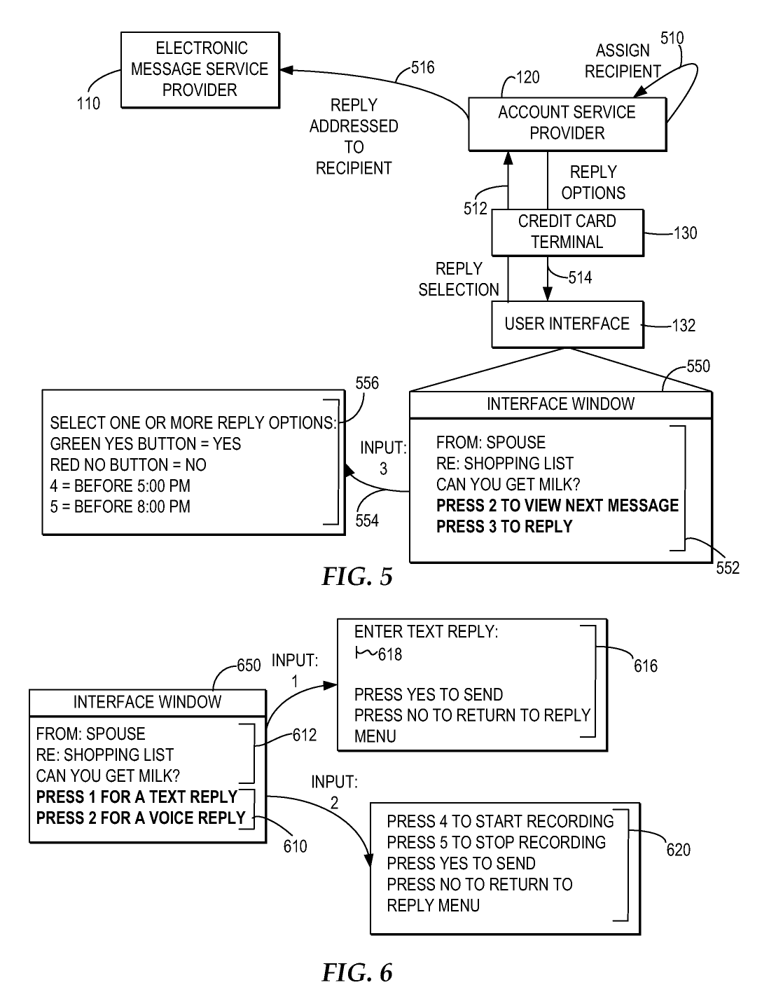

Referring now to FIG. 5, an illustrative block diagram depicts a user interface of a transaction system from which a user sends a reply to an electronic message. It will be understood that while one flow of data from a transaction system is illustrated, other flows of data and options for a user to send electronic messages from a user interface of a transaction system, may be implemented.

In the example, an interface window 550 of user interface 132 includes an electronic message display 552. Electronic message display 552 includes the contents of an electronic message, from “spouse”, where the electronic message is “re: shopping list” and the text of the message reads “can you get milk”. In addition, electronic message display 552 includes multiple user selectable options of the option to “press 2 to view next message” and the option to “press 3 to reply”.

In the example, when the user selects “press 3 to reply”, as illustrated at reference numeral 512, user interface 132 passes the user selection of “3” to transaction terminal 130 and transaction terminal 130 passes the user selection of “3” to account service provider 120. Messaging controller 124 of account service provider 120, upon receipt of a user request to reply to an electronic message from user interface 132, determines which options are available for the user to reply to the message and sends the options as illustrated at reference numeral 514. In one example, messaging controller 124 determines options for the user to reply to the message based on the available interface options at user interface 132. In another example, when a sender of the electronic message replied to composes the electronic message, the sender may specify reply options, such as “yes” or “no”, when the sender composes the electronic message being replied to. Additionally, a user may specify, in the user's account stored in user account database 126, preferences for options provided to the user for reply to an electronic message.

In the example, messaging controller 124 of account service provider 120 selects reply options for the user which limit the user to select a keypad input, which represents a particular response. For example, the options illustrated allow the user to select “green yes button=yes”, “red no button=no”, “4=before 5:00 PM” and “5=before 8:00 PM”, as illustrated when output as selectable reply options 556 within interface window 550.

When viewing electronic message display 556, the user selects an input of “green yes button” and “5”. User interface 132 transmits the user selection of “green yes button” and “5”, to transaction terminal 130 and transaction terminal 130 transmits the user selection to account service provider 120.

Upon receipt of a user selection of “green yes button” and “5” at messaging controller 124 of account service provider 120, messaging controller 124 generates a reply electronic message 510, addressed to the sender of the electronic message replied to by the user, and including the reply messages associated with the user input of “yes” and “before 8:00 PM”. As illustrated at reference numeral 516, messaging controller 124 controls transmission of reply electronic message 510 to electronic message service provider 110, which provides service to the user at user interface 132. Alternatively, credit card service provider 120 may control transmission of reply electronic message 510 directly to the recipient's electronic message service provider.

With reference now to FIG. 6, an illustrative diagram depicts additional examples of reply options selected for a user and displayed at a user interface of a transaction system. In the example, interface window 650 is an interface window of user interface 132. Interface window 650 includes reply selection menu 610 for an electronic message 612. In particular, the user is provided the option to “press 1 for a text reply” and to “press 2 for a voice reply”.

In response to the user pressing “1” when viewing reply selection menu 610, as illustrated at reference numeral 616, the information displayed within interface window 650 is updated to display text reply interface 616. Within text reply interface 616, a text marker 618 indicates the position where a user may enter text through a keypad or keyboard. In addition, the user is provided with an option to “press yes to send” or to “press no to return to reply menu”. The user may be provided with additional or alternate options within a text entry interface, including, but not limited to, additional text editing features, an option to change or add a recipient of the reply, an option to select which type of electronic message format to reply in, and other options that would enable the user to specify a reply message.

In response to the user pressing “2” when viewing reply selection menu 610, as illustrated at reference numeral 620, the information displayed within interface window 650 is updated to display voice response interface 620. Within voice response interface 620, the user is provided with multiple options including options to “press 4 to start recording”, “press 5 to stop recording”, “press yes button to send” or “press no button to return to reply menu”. In particular, the user selecting “4”, triggers user interface 132 to start recording through a microphone and the user selecting “5”, triggers user interface 132 to stop recording through the microphone. In one example, user interface 132 may stream the voice recording, as detected, to transaction terminal 130, which may also stream the voice recording to account service provider 120 for distribution via an electronic communication. In another example, user interface 132 may locally store the voice recording and only transmit the voice recording to transaction terminal 130 if the user selects to send the voice recording as an electronic message by selecting the “yes button”.

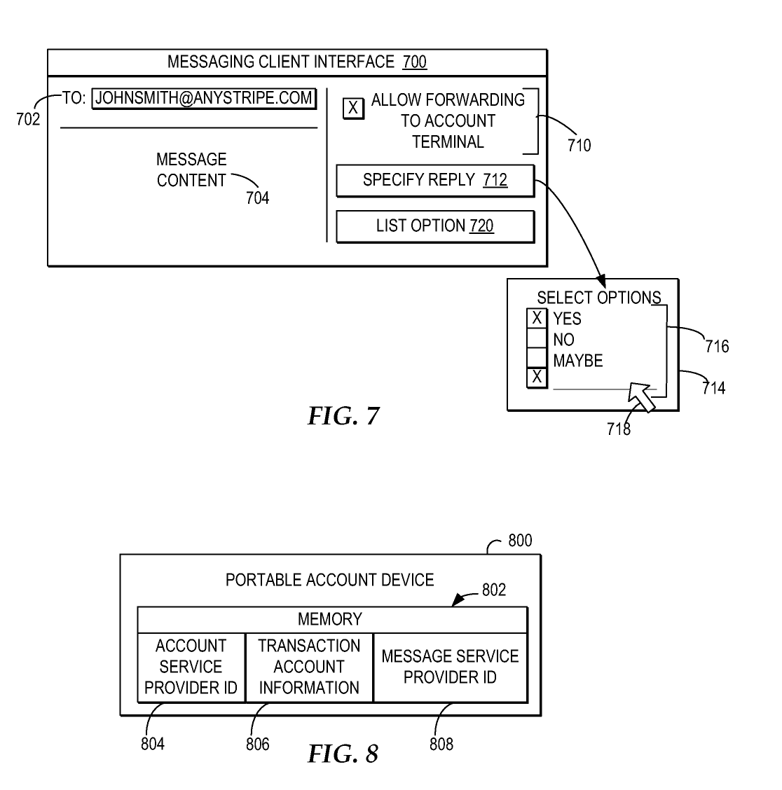

Referring now to FIG. 7, an illustrative diagram depicts an electronic message composition interface for enabling a sender to set options associated with an electronic message being handled by a transaction system. In the example, a messaging client interface 700 enables a sender to specify a recipient address 702 and message content 704. In addition to recipient address 702, a user may specify additional information to include in the header of the electronic message such as other types of addressing or a subject matter of the electronic message. Message content 704 may include, but is not limited to, text, graphics, audio, and video. Messaging client interface 700 may include additional composition and addressing options for the type of electronic messaging format implemented.

In addition, messaging client interface 700 includes an authorization requirement 710 and a reply requirement 712. A user may select authorization requirement 710 to select to enable forwarding of the electronic message. Although not depicted, a user may place an expiration date for the forwarded electronic message. A user may select reply requirement 712 to specify options for a recipient of the electronic message to reply to the electronic message.

In particular, if a user selects reply requirement 712, the user may then select from among additional options illustrated within interface using a cursor 718 or other inputs to make selections from among selectable options 716. In the example, selectable options 716 include an option of “yes”, “no” and user specified. A user may select reply requirement 712 and specify particular reply options to ensure that if the user receives a reply, the user received one of the multiple reply options available, particularly if the recipient is at a user interface with limited output and input options or with limited time constraints for replies.

Additionally, messaging client interface 700 includes a list option 720. By selecting list option 720, the electronic message is set as a list of items. As previously noted, messaging controller 124 within a transaction system may detect electronic messages marked as a list and determine whether items within the list can be marked off based on the purchased associated with a current transaction.

If a user selects an authorization requirement, a reply option, or a list option within messaging client interface 700, the additional selections are added to the header of the electronic message or other metadata associated with the electronic message. In one example, the additional selections are available from a plug-in associated with a transaction system service provider. In another example, the additional selections are available from a user's electronic message service provider.

With reference now to FIG. 8, a block diagram illustrates one embodiment of components of a portable account device. It will be understood that portable account device 800 may include additional or alternate components from the components depicted.

Portable account device 800 may be implemented in a portable device which includes a memory 802 for storing detectable personal information. Examples of memory 802 may include, but are not limited to, a bar code, a magnetic stripe, or a radio frequency identifier (RFID) chip.

Memory 802 may include multiple types of data including, but not limited to, an account service provider identifier (ID) 804, transaction account information 806, and at least one messaging service provider identifier (ID) 808. By including at least one messaging service provider ID 808 within memory 802, when a user presents portable account device 800 at user interface 132, user interface 132 detects all the data from memory 802, including at least one messaging service provider ID 808, and passes at least one messaging service provider ID 808 to a system enabled to log in to one or more of the identified electronic messaging service providers and access electronic messages addressed to the user for delivery to user interface 132. Thus, rather than a user having to provide an account service provider system with the user's messaging service provider information for storage by the account service provider system, the user may present portable account device 800, which includes both the user's transaction account information and the user's electronic messaging information together to any system enabled to read portable account device 800 and access an electronic message service provider system to deliver accessed electronic messages from the electronic message service provider system.

For memory 802 to include at least one messaging service provider ID 808, a user may be issued portable account device 800 with the messaging service already specified. For example, a credit card account provider may issue portable account device 800 with a user's transaction account information and with a particular electronic message service already identified, where the user separately signs up for electronic messaging service from the selected electronic message service provider, with the transaction account information to identify the user. In addition, an electronic message service provider may provide a service where an electronic messaging subscriber can also select to subscribe to a credit card service partnered with the electronic message service provider, such that the issued portable account device 800 already identifies account service provider and the electronic message service provider. Alternatively, memory 802 on portable account device 800 may be adjustable by different types of writing device depending on the type of memory 802. For example, a transaction account provider may issue portable account device 800 with the user's transaction account information, but enable a user to select for a writing device to write the identifiers for one or more electronic message service providers to memory 802.

Referring now to FIG. 9, an illustrative diagram depicts one embodiment of an electronic message delivery system based on an electronic message service provider specified on a portable account device. In the example, transaction terminal 130 is an account provider kiosk 912 which includes messaging controller 124 and a device reader 910 for reading portable account devices, such as portable account device 800.

In the example, portable account device 800 includes memory 802 with a credit card (CC) service provider specified as “bankA” illustrated at reference numeral 902, with a transaction account number of “23200120011” illustrated at reference numeral 904, with a messaging service provider of “mail.anystripe.com” illustrated at reference numeral 906 and with a user name of “samdavis” illustrated at reference numeral 908.

In particular, in the example, when account provider kiosk 912 receives the user information read by device reader 910 from portable account device 800, as illustrated at reference numeral 950, account provider kiosk 912 may prompt the user, via user interface 132, to provide a password or other authorization requirement. In one example, the same password is used to authorize a transaction to the user's account as is used to authorize access to the user's electronic messages. In another example, account provider kiosk 912 may also prompt the user, at user interface 132, to provide a separate authorization requirement for authorizing access to the user's electronic messages or for authorizing accessing to the service provider by account provider kiosk 912.

In one example, where account provider kiosk 912 is a financial account provider ATM, account provider kiosk 912 may handle one or both of a financial transaction between the user and the user's financial service provider, such as a bank or credit card service provider, and the user's messaging service provider. For example, account provider kiosk 912 may handle a financial transaction with account service provider 120 and also access the messages for the user's messaging service provider “anystripe.com” at reference numeral 920. Account provider kiosk 912 may charge a flat fee or an hourly fee for a user to access the user's electronic mail messages at user interface 132, similar to the fees that an ATM will charge a user for performing financial transactions.

In another example, where account provider kiosk 912 is another type of service provider, such as a flight check-in service kiosk, a user may check-in for a flight by first identifying the user by swiping a portable account device bearing the account number that the user used to pay for a ticket. When the user swipes the portable account device, in one example, such as portable account device 800, the portable account device also includes a message service provider and user information, such that account provider kiosk 912, in addition to checking in a user for flights, may also access electronic messages for the user. In addition, if portable account device 800 does not include the message service provider information, account provider kiosk 912 may access a user's profile from account service provider 120 or another database, based on account number 914, where the user's profile includes the user's message service provider and login information.

Referring now to FIG. 10, a high level logic flowchart depicts a process and program for controlling delivery of electronic messages to a user interface within a transaction system. In the example, the process starts at block 1000 and thereafter proceeds to block 1020. Block 1020 depicts a determination whether the user interface detects user account identification. If user account identification is detected, then the process passes to block 1022. Block 1022 depicts transmitting the user identification to a messaging controller within the transaction system and next, block 1024 illustrates monitoring the user presence at the user interface. In monitoring the user presence at the user interface a user no longer present may be indicated from a user selecting inputs, such as a selection to logout. In addition, in monitoring the user presence at the user interface, the user interface may include motion detectors, image detectors, or other monitoring devices that detect whether the user is still physically present in the proximity of the user interface. Further, other types of presence monitoring may be performed.

When the messaging controller receives the user identification, the messaging controller determines, as illustrated at block 1002, whether the user account identification includes messaging service information. If the user account identification includes messaging service information, then the process passes to block 1006. Otherwise, at block 1002, if the user account identification does not include messaging service information, then the messaging controller accesses the messaging service provider and login information for a user from a user account database based on the user account identification received, and the process passes to block 1006.

Block 1006 depicts requesting messages for the user from the user's electronic message service provider with the user's login information. Next, block 1008 depicts a determination whether the messaging controller receives electronic messages addressed to the user from the user's electronic message service provider. If the messaging controller does not receive electronic messages, then the process ends. If the messaging controller does receive at least one electronic message for the user, then the process passes to block 1010.

Block 1010 illustrates formatting and filtering the electronic messages according to the user profile and the user interface availability. Next, block 1012 depicts delivering the formatted and filtered electronic messages to the user interface for output to the user.

As illustrated at block 1026, the user interface monitors whether the user is still at the interface and, responsive to receiving electronic messages, if the user is not still at the interface, the process ends. If the user is still at the interface, then the process passes to block 1028.

Block 1028 depicts controlling the user interface for the user to view the electronic messages and select to reply to electronic messages. Next, block 1030 illustrates a determination whether the user interface detects a user select a reply to an electronic message. If the user does not select to reply, then the process passes to block 1034. Block 1034 monitors whether a logout request or timeout from no activity is detected. If a logout or timeout is detected, then the process passes to block 1036. Block 1036 depicts clearing the electronic message viewing option, and the process ends. Otherwise, at block 1030, if the user selects to reply to an electronic message, the process passes to block 1032. Block 1032 depicts transmitting the reply request to the account provider system.

At block 1014, if the messaging controller receives a reply request, then the account provider system assigns one or more recipient addresses to the reply message. Next, block 1016 depicts send the addressed reply messages to one or more electronic message service providers and the process ends.

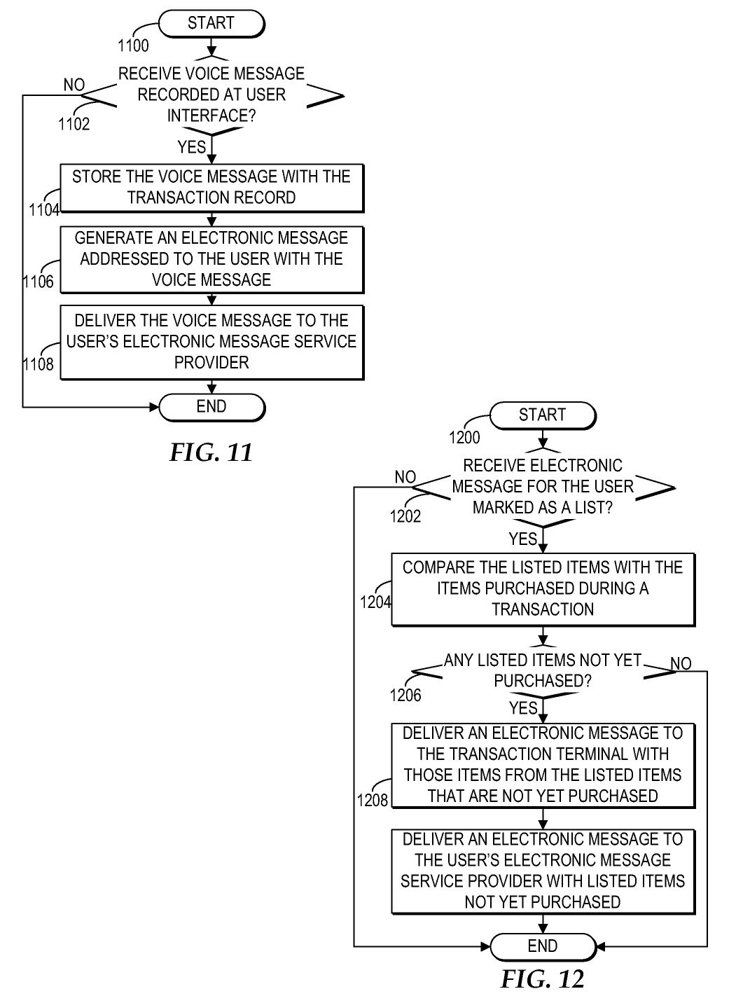

With reference now to FIG. 11, a high level logic flowchart depicts a process and program for a messaging controller of a transaction system to manage voice messages recorded by a user at a user interface. In the example, the process starts at block 1100 and thereafter proceeds to block 1102. Block 1102 depicts a determination whether the messaging controller within a transaction system receives a voice message recorded at a user interface. In particular, a user may select, while at a user interface performing a transaction, to record a voice message in association with a transaction.

At block 1102, if a user selects to record a voice message and the messaging controller receives the voice message packet from the user interface, then the process passes to block 1104. Block 1104 depicts storing the voice message with the transaction record for the transaction being performed. In addition, block 1006 illustrates generating an electronic message addressed to the user with the voice message and block 1108 depicts delivering the voice message to the user's electronic message service provider, and the process ends. By enabling a user to record a voice message in association with a transaction and storing the voice message and/or offering the user the option to receive an electronic message with the voice message, the user is able to add to the record associated with a transaction. For example, a user may record a voice message of “business lunch with Ted”, which will enable the user to later itemize the transaction.

Referring now to FIG. 12, a high level logic flowchart depicts a process and program for a messaging controller of a transaction system to manage electronic messages marked as lists. In the example, the process starts at block 1200 and thereafter proceeds to block 1202. Block 1202 depicts a determination whether the messaging controller of a transaction system receives an electronic message for a user, from the user's electronic message service provider, marked as a list. If the account provider system receives an electronic message marked as a list, then the process passes to block 1204. Block 1204 illustrates comparing the listed items with the items purchased during a transaction. Next, block 1206 depicts a determination whether there are any listed items that are not yet purchased in view of the current purchases. If all items are purchased, then the process ends. If there are listed items that are not yet purchased, then the process passes to block 1208. Block 1208 illustrates delivering an electronic message to the user interface with those items from the listed items that are not yet purchased. Next, block 1210 depicts delivering an electronic message, marked as a list, to the user's electronic message service provider with listed items not yet purchased, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for delivering an electronic message to a user, comprising:
detecting, at a financial transaction system, an identifier for a user requesting a financial transaction at an interface of said financial transaction system;
accessing, at said financial transaction system, from an electronic message service provider for said user accessed based on said identifier, at least one electronic message addressed to said user and sent to said user over a network for delivery to said user by said electronic message service provider; and
delivering, at said interface of said financial transaction system, said electronic message to said user.

2. The method according to claim 1, further comprising:
enabling, at said interface of said financial transaction system, for said user to compose a second electronic message; and
controlling delivery, from said financial transaction system, of said second electronic message to an addressee of said second electronic message.

3. The method according to claim 1, further comprising:
receiving, at said financial transaction system, said electronic message from said electronic message service provider for said user;
storing, at said financial transaction system, said electronic message in association with said identifier for said user; and
after storing said electronic message in association with said identifier for said user, responsive to detecting said identifier for said user entered at said interface of said financial transaction system, accessing said stored electronic message and delivering said stored electronic message to said interface.

4. The method according to claim 1, further comprising:
detecting, at said financial transaction system, said electronic message marked as a list;
comparing a plurality of items listed in a contents of said electronic message with at least one item associated with said financial transaction; and
delivering said electronic message to said interface indicating which of said plurality of items need to be purchased.

5. The method according to claim 1, further comprising:
receiving, at said financial transaction system, said electronic message with a reply option set to limit a reply to a selection of responses;
delivering said electronic message to said interface with a selectable option to reply to said electronic message; and
responsive to said user requesting to reply to said electronic message, limiting said user to select one of said selection of responses for a reply message.

6. The method according to claim 1, further comprising:
receiving, at said financial transaction system, a voice message recorded by said user at said interface;
storing, at said financial transaction system, said voice message in association with a record of said financial transaction; and
delivering to said electronic message service provider from said financial transaction system, a second electronic message addressed to said user comprising said voice message and said record of said financial transaction.

7. The method according to claim 1, wherein detecting, at a financial transaction system, an identifier for a user requesting a financial transaction at an interface of said financial transaction system, further comprises:
detecting, from a portable account device presented by said user at said interface, a financial account identifier for said user; and
accessing, at said financial transaction system, said identifier for said user for use in accessing said electronic message from said electronic message service provider, from a database of financial account identifiers each separately associated with a particular electronic message service provider and messaging identifier.

8. The method according to claim 1, wherein detecting, at a financial transaction system, an identifier for a user requesting a financial transaction at an interface of said financial transaction system, further comprises:
detecting said identifier from a portable account device presented by said user at said interface identifying said electronic message service provider and messaging identifier for said user to access an account for said user facilitated by said electronic message service provider.

9. A system for delivering an electronic message to a user, comprising:
a financial transaction system communicatively connected to a network and comprising an interface for access by a user;
said financial transaction system for detecting an identifier for said user requesting a financial transaction at said interface;
said financial transaction system for accessing, from an electronic message service provider for said user accessed based on said identifier, over said network at least one electronic message addressed to said user and sent to said user over said network for delivery to said user by said electronic message service provider; and
said financial transaction system for delivering, at said interface said electronic message to said user.

10. The system according to claim 9, further comprising:
said financial transaction system for enabling said user to compose a second electronic message via said interface; and
said financial transaction system for controlling delivery via said network of said second electronic message to an addressee of said second electronic message.

11. The system according to claim 9, further comprising:
said financial transaction system for receiving said electronic message from said electronic message service provider for said user via said network;
said financial transaction system for storing a copy of said electronic message in association with said identifier for said user; and
said financial transaction system, after storing said electronic message in association with said identifier for said user, responsive to detecting said identifier for said user entered at said interface, for accessing said stored electronic message and delivering said stored electronic message to said interface.

12. The system according to claim 9, further comprising:
said financial transaction system for detecting said electronic message marked as a list;
said financial transaction system for comparing a plurality of items listed in a contents of said electronic message with at least one item associated with said financial transaction; and
said financial transaction system for delivering said electronic message to said interface with an indication of which of said plurality of items need to be purchased.

13. The system according to claim 9, further comprising:
said financial transaction system for receiving said electronic message with a reply option set to limit a reply to a selection of responses;
said financial transaction system for delivering said electronic message to said interface with a selectable option to reply to said electronic message; and
said financial transaction system, responsive to said user requesting to reply to said electronic message, for limiting said user to select one of said selection of responses for a reply message.

14. The system according to claim 9, further comprising:
said financial transaction system for receiving a voice message recorded by said user at said interface;
said financial transaction system for storing said voice message in association with a record of said financial transaction; and
said financial transaction system for delivering to said electronic message service provider a second electronic message addressed to said user comprising said voice message and said record of said financial transaction.

15. The system according to claim 9, wherein said financial transaction system for detecting an identifier for a user requesting a financial transaction at an interface of said financial transaction system, further comprises:
means for detecting, from a portable account device presented by said user at said interface, a financial account identifier for said user; and
means for accessing said identifier for said user for use in accessing said electronic message from said electronic message service provider, from a database of financial account identifiers each separately associated with a particular electronic message service provider and messaging identifier.

16. The system according to claim 9, wherein said financial transaction system for detecting an identifier for a user requesting a financial transaction at an interface of said financial transaction system, further comprises:
means for detecting said identifier from a portable account device presented by said user at said interface identifying said electronic message service provider and messaging identifier for said user to access an account for said user facilitated by said electronic message service provider.

17. A program for delivering an electronic message to a user, said program embodied in a computer-readable medium, said program comprising computer-executable instructions which cause a computer to perform the steps of:
detecting an identifier for a user requesting a financial transaction at an interface of a financial transaction system;
accessing from an electronic message service provider for said user accessed based on said identifier, at least one electronic message addressed to said user and sent to said user over a network for delivery to said user by said electronic message service provider; and
delivering at said interface of said financial transaction system said electronic message to said user.

18. The program according to claim 17, further comprising:
enabling, at said interface of said financial transaction system, for said user to compose a second electronic message; and
controlling delivery, from said financial transaction system, of said second electronic message to an addressee of said second electronic message.

19. The program according to claim 17, further comprising:
receiving, at said financial transaction system, said electronic message from said electronic message service provider for said user;
storing, at said financial transaction system, said electronic message in association with said identifier for said user; and
after storing said electronic message in association with said identifier for said user, responsive to detecting said identifier for said user entered at said interface of said financial transaction system, accessing said stored electronic message and delivering said stored electronic message to said interface.

20. The program according to claim 17, further comprising:
receiving, at said financial transaction system, a voice message recorded by said user at said interface;
storing, at said financial transaction system, said voice message in association with a record of said financial transaction; and
delivering to said electronic message service provider from said financial transaction system, a second electronic message addressed to said user comprising said voice message and said record of said financial transaction.
